(19) United States
(12) Patent Application Publication
(10) Pub. No.: US 2026/0364472 A1
(43) Pub. Date: Nov. 19, 2026

(54) INFORMATION PROCESSING DEVICE AND GAME PLAY METHOD

(71) Applicant: Sony Interactive Entertainment Inc., Tokyo (JP)

(72) Inventors: Tatsuki Amimoto, Tokyo (JP); Nobuyuki Nakamura, Kanagawa (JP)

(73) Assignee: Sony Interactive Entertainment Inc., Tokyo (JP)

(21) Appl. No.: 19/148,177

(22) PCT Filed: Feb. 14, 2023
(86) PCT No.: PCT/JP2023/004907

§ 371 Date: Jul. 15, 2025

(51) Int. Cl. A63F 13/79; A63F 13/67

(52) U.S. Cl. CPC A63F 13/79; A63F 13/67

(57) ABSTRACT

A reception section 110 accepts operation information input by a user, and a game execution Section 112 executes a game according to the operation information. A notification section 136 generates notification information notifying the user of a play unit in which play by an agent is available, and an output processing section 120 displays the notification information on a game image in an overlapping manner. A game play controller 132 causes an agent generated for each play unit to play the game.

### TECHNICAL FIELD

The present disclosure relates to a technique in which an agent plays a game in place of a user.

### BACKGROUND ART

PTL 1 discloses a system in which, by having a game play controller take over a game play, an artificial intelligence (AI) character progresses the game in place of a user. PTL 2 discloses a method of training a machine learning model in such a way as to simulate the game play of the user by use of game play data obtained when the user plays a video game. The machine learning model is an artificial neural network, and learns and simulates a game play style and a tendency of the user. By training the machine learning model, it is possible to allow an AI bot of the user to play the game play that simulates the user.

### CITATION LIST

### Patent Literature

[PTL 1] Japanese Translation of PCT International Application Publication No. JP-T-2019-520154

[PTL 2] Japanese Translation of PCT International Application Publication No. JP-T-2022-525413

### SUMMARY

### Technical Problem

In a strategy game such as chess, Japanese chess, or Go, evolution of an AI agent has been remarkable, and there also has been an AI agent with those surpassing performances of humans. Meanwhile, as for a game having a relatively complicated rule, such as a role-playing game or an action game, generation of an AI agent with high play accuracy is not easy.

In general, an AI agent is often used as an opponent of the user. However, if the play accuracy of the AI agent increases, the user allows the AI agent to play the game in place of the user, thereby making it possible to progress the game. In view of this, there is demanded a system in which the user can use an AI agent with a high play accuracy effectively.

### Solution to Problem

An information processing device according to an aspect of the present disclosure includes one or more processors including hardware, in which the one or more processors accept operation information input by a user, execute a game according to the operation information, notify the user of a play unit in which play by an agent is available, and cause the agent to play the play unit in place of the user.

A game play method according to another aspect of the present disclosure is a method for playing a game by an information processing device, the method including accepting operation information input by a user, executing a game according to the operation information, notifying the user of a play unit in which play by an agent is available, and causing the agent to play the play unit in place of the user.

Note that any combinations of the above components and conversions of the expressions of the present disclosure between a method, a device, a system, a recording medium, a computer program, and the like are also effective as modes of the present invention.

### BRIEF DESCRIPTION OF DRAWINGS

FIG. 1 is a diagram illustrating a game system according to an embodiment.

FIG. 2 is a diagram illustrating a hardware configuration of an information processing device.

FIG. 3 is a diagram illustrating functional blocks of the information processing device.

FIG. 4 is a diagram illustrating an example of a game image.

FIG. 5 is a diagram illustrating an example of a plurality of tasks constituting an activity.

FIG. 6 is a diagram illustrating functional blocks of a server device.

FIG. 7 is a diagram illustrating an example of a notification region to be displayed.

FIG. 8 is a diagram illustrating an example of a notification region to be displayed.

FIG. 9 is a diagram illustrating an example of a notification region to be displayed.

FIG. 10 is a diagram illustrating an example of a notification region to be displayed.

FIG. 11 is a diagram illustrating an example of a notification region to be displayed.

### DESCRIPTION OF EMBODIMENT

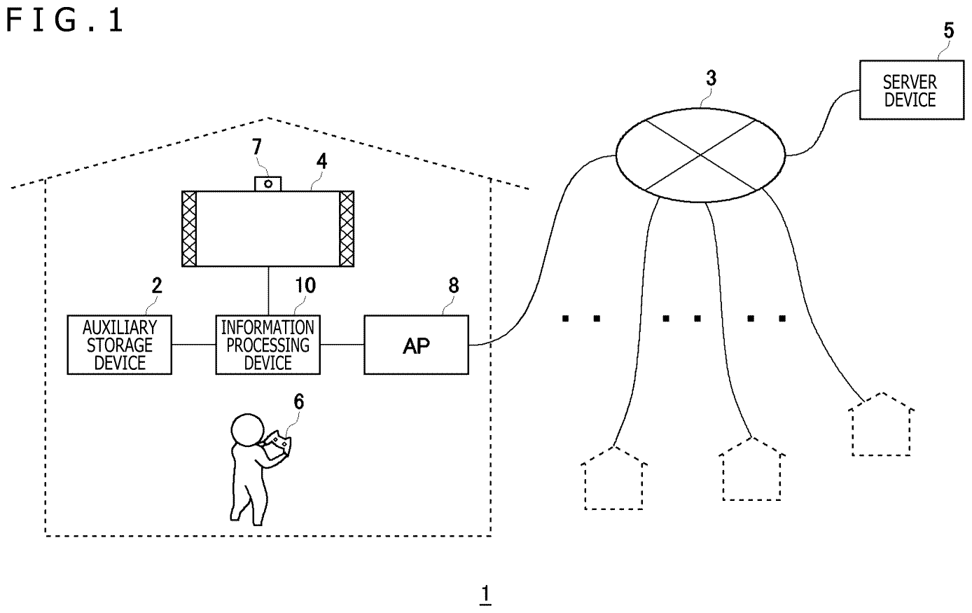

FIG. 1 is a game system 1 according to an embodiment of the present disclosure. The game system 1 according to the embodiment includes an information processing device 10 operated by a user and a server device 5. An access point (hereinafter, called an “AP”) 8 has a function of a wireless access point and a router, and the information processing device 10 connects to the AP 8 in a wireless or wired manner to connect to the server device 5 on a network 3 such as the Internet through the AP 8 in such a manner as to be able to communicate with the server device 5. Although FIG. 1 illustrates one user and one information processing device 10, in the game system 1, a plurality of information processing devices 10 operated by a plurality of users are connected with one another through the server device 5 and the network 3.

The information processing device 10 connects to an input device 6 operated by a user in a wireless or wired manner. The input device 6 outputs, to the information processing device 10, information resulting from the user performing an operation. Upon accepting such operation information from the input device 6, the information processing device 10 reflects the operation information to processing by system software or game software and causes an output device 4 to output the result of the processing. In the game system 1, the information processing device 10 is a game device (game console) that executes a game, and the input device 6 is equipment such as a game controller that supplies operation information from a user to the information processing device 10. Note that the input device 6 may be an input interface such as a keyboard or a mouse.

An auxiliary storage device 2 is a large-capacity storage device such as a hard disk drive (HDD) and a solid state drive (SSD) and may be a built-in storage device or may be an external storage device that connects the information processing device 10 through a universal serial bus (USB) or the like. The output device 4 may be a television having a display that outputs an image and a speaker that outputs sound. The output device 4 may be connected with the information processing device 10 through a cable or may be connected therewith wirelessly.

A camera 7 serving as an imaging device is provided in the vicinity of the output device 4, and captures an image of a space around the output device 4. While FIG. 1 illustrates an example in which the camera 7 is attached to an upper portion of the output device 4, the camera 7 may be disposed on a side portion or a lower portion of the output device 4. In any case, the camera 7 is disposed at a position that enables capturing of an image of a user who is positioned in front of the output device 4. The camera 7 may be a stereo camera.

The server device 5 provides a network service to the user of the game system 1. The server device 5 manages a user account which identifies each user, and each user uses the user account to sign in to the network service provided by the server device 5. By signing in to the network service from the information processing device 10, the user can register, in the server device 5, save data regarding a game or a trophy that is a virtual prize obtained during game play. By being registered in the server device 5, the save data and the trophies can be synchronized between devices even in a case where the user uses an information processing device different from the information processing device 10.

The server device 5 according to the embodiment generates an AI agent who plays a game, and has a function of providing the AI agent to the information processing device 10. In order to generate the AI agent, the server device 5 collects pieces of play data indicating statuses of the game play from the plurality of information processing devices 10. The play data in the embodiment may be operation information obtained by the player (the user) operating the input device 6 or may be a game image (play image) rendered according to the operation information of the player. The server device 5 machine-learns a game operation model by use of play data associated with one or more players, to generate an AI agent who can automatedly play a game (hereinafter, simply referred to as an “agent” in some cases).

In the game system 1 according to the embodiment, the user can cause the agent to play the game in place of the user. During the game play by the agent, the user does not perform any game operation regarding the game, and the agent automatedly or automatically plays the game. For example, when the user cannot operate the game for a meal, the user causes the agent to play the game in place of the user, allowing the game to progress. Note that the user can also take over the operation for the game being played by the agent.

The agent according to the embodiment is generated as a result of learning of the past play data associated with one or more of players. The agent is a game operation model that has learned, and automatedly and automatically generates the operation information of the input device 6 according to a progress status of the game. The agent may generate a game command with which the game becomes understandable. Before the start of the game, the learned game operation model is provided by the server device 5 to the information processing device 10, and assists the game play of the user.

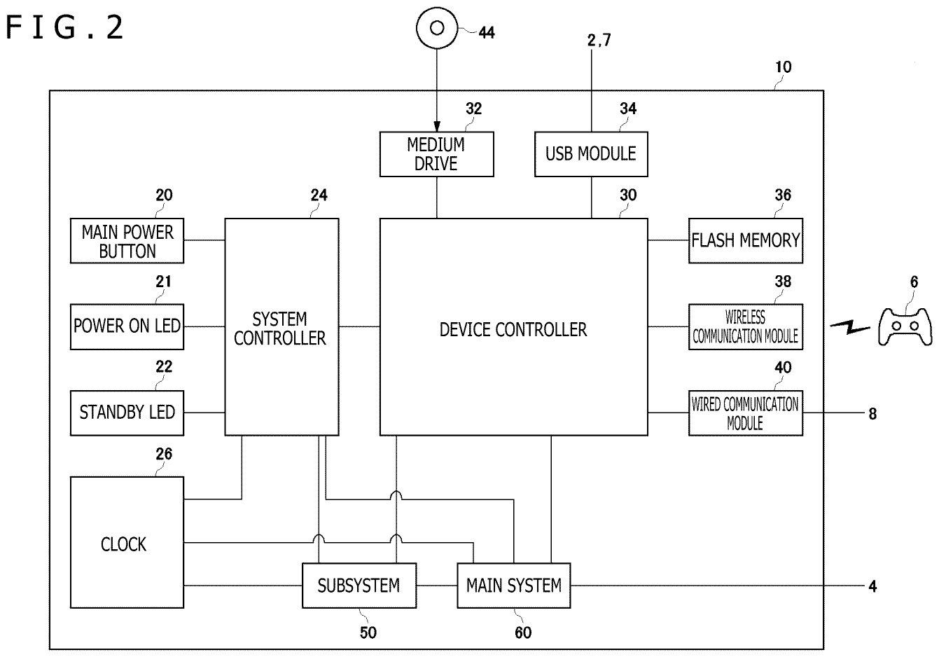

FIG. 2 illustrates a hardware configuration of the information processing device 10. The information processing device 10 includes a main power button 20, a power ON light emitting diode (LED) 21, a standby LED 22, a system controller 24, a clock 26, a device controller 30, a medium drive 32, a USB module 34, a flash memory 36, a wireless communication module 38, a wired communication module 40, a subsystem 50, and a main system 60.

The main system 60 includes a main central processing unit (CPU), a memory which is a main storage device, a memory controller, a graphics processing unit (GPU), etc. The GPU is mainly used in arithmetic processing for a game program. The main CPU has a function of activating system software and executing a game program installed in the auxiliary storage device 2 in an environment provided by the system software. The subsystem 50 includes a sub CPU, a memory that is a main storage device, a memory controller, etc., but is not provided with a GPU.

The main CPU has a function of executing a game program installed onto the auxiliary storage device 2, but the sub CPU does not have such a function. However, the sub CPU has a function of accessing the auxiliary storage device 2 and a function of transmitting and receiving data to and from the server device 5. The sub CPU includes only such limited processing functions, and therefore can operate with lower power consumption than the main CPU. These functions of the sub CPU are executed when the main CPU is in a standby state.

The main power button 20 is an input unit with respect to which an operation input is performed by a user, is provided on the front surface of the housing of the information processing device 10, and is operated in order to turn on or off power supply to the main system 60 in the information processing device 10. The power ON LED 21 lights up when the main power button 20 is turned on, and the standby LED 22 lights up when the main power button 20 is turned off. The system controller 24 detects a press of the main power button 20 by a user.

The clock 26 is a real-time clock, generates current date and time information, and supplies this current date and time information to the system controller 24 or the subsystem 50 and the main system 60.

The device controller 30 is configured as a large-scale integrated circuit (LSI) that executes the handover of information between devices, as with a southbridge. As illustrated, devices such as the system controller 24, the medium drive 32, the USB module 34, the flash memory 36, the wireless communication module 38, the wired communication module 40, the subsystem 50, and the main system 60 are connected to the device controller 30. The device controller 30 controls the timings of data transfers by absorbing differences in electrical characteristics or differences in data transfer speeds between the respective devices.

The medium drive 32 is a drive device that is mounted with and drives a read-only memory (ROM) medium 44 to which license information and application software such as a game are recorded, and reads out a program, data, etc., from the ROM medium 44. The ROM medium 44 is a read-only recording medium such as an optical disc, a magneto-optical disc, or a Blu-ray Disc.

The USB module 34 is a module for connecting to an external device by a USB cable. The USB module 34 may be connected to the auxiliary storage device 2 and the camera 7 by a USB cable. The flash memory 36 is an auxiliary storage device that configures an internal storage. The wireless communication module 38 wirelessly communicates with the input device 6 by a communication protocol such as a Bluetooth (registered trademark) protocol or an Institute of Electrical and Electronics Engineers (IEEE) 802.11 protocol. The wired communication module 40 performs wired communication with an external device and is connected to the network 3 via the AP 8.

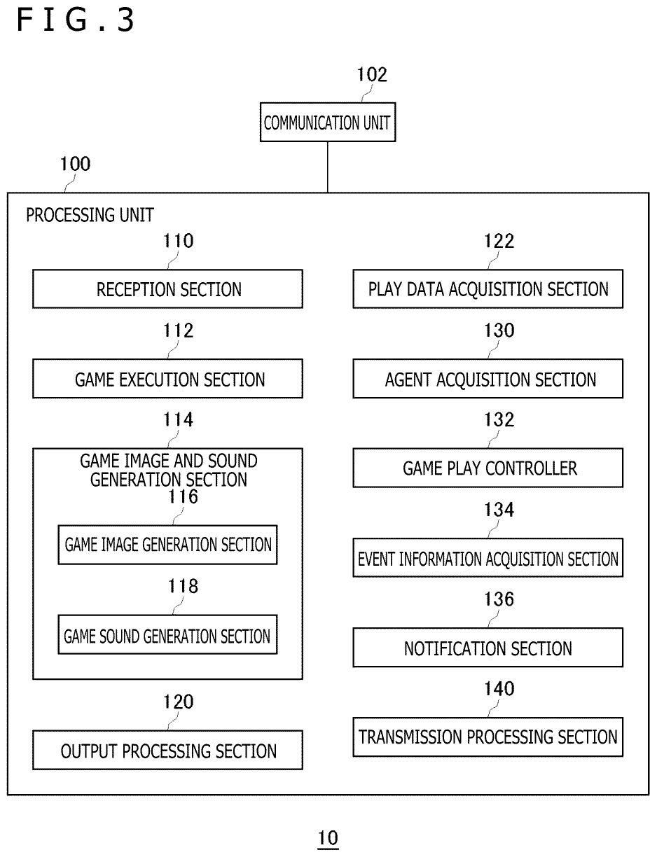

FIG. 3 illustrates functional blocks of the information processing device 10. The information processing device 10 includes a processing unit 100 and a communication unit 102, and executes game software. The processing unit 100 includes a reception section 110, a game execution section 112, a game image and sound generation section 114, an output processing section 120, a play data acquisition section 122, an agent acquisition section 130, a game play controller 132, an event information acquisition section 134, a notification section 136, and a transmission processing section 140. The game image and sound generation section 114 has a game image generation section 116 and a game sound generation section 118.

The information processing device 10 includes a computer, and various functions illustrated in FIG. 3 are implemented when the computer executes programs. The computer includes, as hardware, a memory to which programs are to be loaded, one or more processors that execute the programs loaded, an auxiliary storage device, other LSIs, and the like. The processor includes a plurality of electronic circuits including semiconductor integrated circuits and LSIs. The plurality of electronic circuits may be mounted onto one chip or may be mounted onto a plurality of chips. The functional blocks illustrated in FIG. 3 are implemented by cooperation between hardware and software. Accordingly, it should be understood by those skilled in the art that these functional blocks can be implemented in various forms including hardware only, software only, or a combination of the two.

The communication unit 102 receives information (operation information) obtained by the user operating the input device 6 for the game play and provides the information to the reception section 110. The reception section 110 accepts the operation information input by the user and provides it to the game execution section 112 as well as to the play data acquisition section 122. The communication unit 102 communicates with the server device 5 and transmits and receives various pieces of information and data. The communication unit 102 may have functions of both the wireless communication module 38 and the wired communication module 40.

The game execution section 112 executes game software on the basis of the operation information input by the user. The game software includes at least a game program, image data, and sound data. While the user is playing the game, the reception section 110 accepts the operation information of the user, and the game execution section 112 executes arithmetic processing to move a player character in a virtual space on the basis of the operation information of the user. The game image generation section 116 includes a GPU, and receives a result of the arithmetic processing in the virtual space, to generate a game image from a viewpoint position (virtual camera) in the virtual space. Moreover, the game sound generation section 118 generates game sound from the viewpoint position in the virtual space. The output processing section 120 outputs the game image and the game sound from the output device 4.

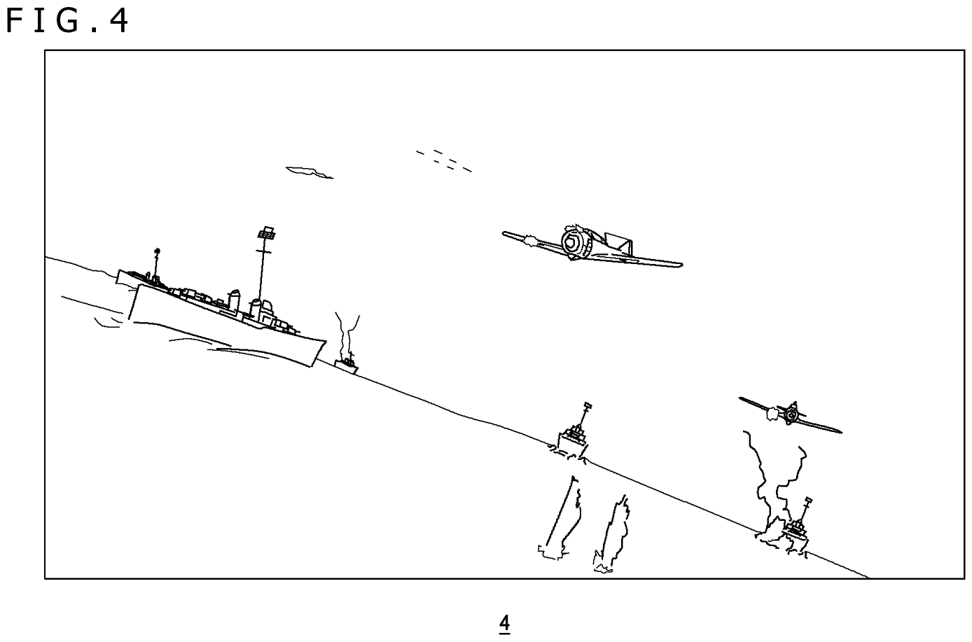

FIG. 4 illustrates an example of a game image displayed on the output device 4.

When an event occurs in the game, the game program according to the embodiment outputs event information including information for identifying an event that has occurred (event identification (ID)) to the event information acquisition section 134.

The game includes a plurality of activities to which a start condition and an end condition are set. An activity is one of play units including a stage, a quest, a mission, a tournament, a session, or the like that is incorporated in the game, and game progress from the establishment of the start condition to the establishment of the end condition constitutes one activity. The activity is appropriately set by a game manufacturer, and, for example, one quest that appears during the progress of the game may constitute one activity, while a plurality of quests may constitute one activity. In a case in which the plurality of quests constitutes one activity, completing all the plurality of quests becomes the end condition of the activity.

Although one activity is one play unit, it may be constituted by a plurality of tasks. When setting one activity, the game manufacturer divides the relevant activity into some pieces, allowing a plurality of tasks to be set to the respective pieces. In this case, one activity is constituted by a plurality of tasks.

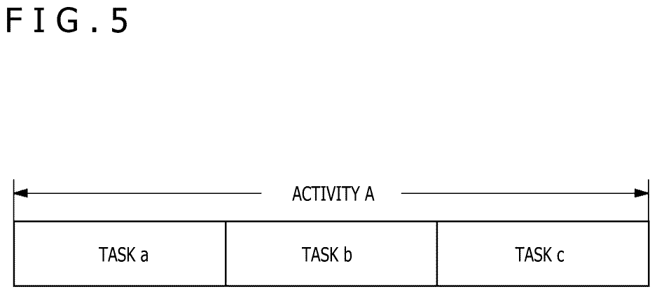

FIG. 5 illustrates an example of a plurality of tasks constituting one activity. In this example, an activity A includes a task a, a task b, and a task c, and the user accomplishes the tasks, in the order of the task a, the task b, and the task c, thereby accomplishing the activity A. For example, in a case in which three quests constitutes the activity A, the task a may be allocated to a first quest, the task b to a second quest, and the task c to a third quest. In addition, in a case in which one quest is set as the activity A, the task a may be allocated to the first game scene, the task b to the middle game scene, the task c to the last game scene. Each task constitutes one play unit. The game manufacturer has an authority of freely setting a play unit serving as an activity or a task.

When the activity is referred to as a “first play unit” and the task is referred to a “second play unit,” the following relation is satisfied between them.

first play unit>second play unit

Note that one task may be constituted by a plurality of subtasks, and in this case, the subtask may be referred to as a “third play unit.”

When starting an activity, the game program outputs event information including information for identifying a start event of the activity (event ID) to the event information acquisition section 134. In addition, when ending an activity, the game program outputs event information including information for identifying an end event of the activity (event ID) to the event information acquisition section 134. The event information may include not only the event ID, but also information for identifying an activity (activity ID), and may include information indicating a result of performing the activity (for example, success or failure). The event ID is set to be different for each activity.

Similarly, when starting a task, the game program outputs event information including information for identifying a start event of the task (event ID) to the event information acquisition section 134. In addition, when ending a task, the game program outputs event information including information for identifying an end event of the task (event ID) to the event information acquisition section 134. The event information may include not only the event ID, but also information for identifying the task (task ID), and may include information indicating a result of performing the task (for example, success or failure). The event ID is set to be different for each task.

When acquiring the event information, the event information acquisition section 134 generates event data by adding, to the event information, a user identifier (user account) for identifying the user, a game identifier (game ID) for identifying the game, and time information (time stamp) indicating a time at which an event has occurred, thereby providing the generated event data to the transmission processing section 140. The game program may output event information including a game ID and/or a time stamp to the event information acquisition section 134. The transmission processing section 140 transmits event data provided from the event information acquisition section 134 through the communication unit 102 to the server device 5.

As described above, when accepting the operation information of the user, the reception section 110 provides the operation information to the game execution section 112 as well as to the play data acquisition section 122. The play data acquisition section 122 generates play data by adding, to the provided operation information, the user account, the game ID, and time information (time stamp) for indicating a time at which the operation information is provided, and provides the generated play data to the transmission processing section 140. The transmission processing section 140 transmits the play data provided from the play data acquisition section 122 through the communication unit 102 to the server device 5.

Note that the play data acquisition section 122 may provide not only the operation information of the user, but also the game image (play video image) generated by the game image generation section 116, as play data, to the transmission processing section 140. At this time, the transmission processing section 140 transmits, as play data, the operation information of the user and the play video image, through the communication unit 102 to the server device 5.

In the game system 1, a transmission process of the event data and the play data is performed by all of the information processing devices 10 connected to the server device 5, and the server device 5 collects pieces of event data and play data regarding various games, from the plurality of information processing devices 10.

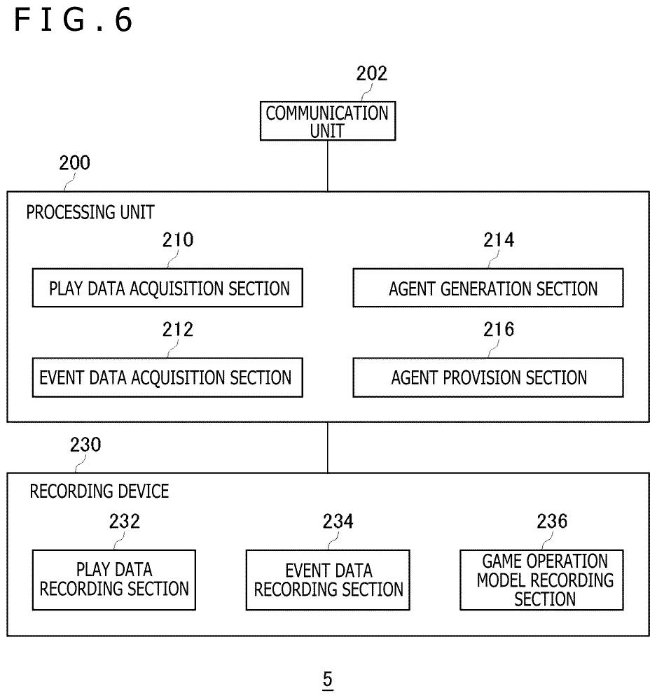

FIG. 6 indicates functional blocks of the server device 5. The server device 5 of the embodiment includes a processing unit 200, a communication unit 202, and a recording device 230. The processing unit 200 includes a play data acquisition section 210, an event data acquisition section 212, an agent generation section 214, and an agent provision section 216. When acquiring play data transmitted from the information processing device 10, the play data acquisition section 210 records it in the play data recording section 232. When acquiring event data transmitted from the information processing device 10, the event data acquisition section 212 records it in the event data recording section 234. When generating an agent who is to play the game, the agent generation section 214 records it in the game operation model recording section 236.

The server device 5 is an information processing device that includes a computer, and various functions illustrated in FIG. 6 are implemented when the computer executes programs. The computer includes, as hardware, a memory to which programs are to be loaded, one or more processors that execute the programs loaded, an auxiliary storage device, other LSIs, and the like. The processor includes a plurality of electronic circuits including semiconductor integrated circuits and LSIs. The plurality of electronic circuits may be mounted onto one chip or may be mounted onto a plurality of chips. The functional blocks illustrated in FIG. 6 are implemented by cooperation between hardware and software. Accordingly, it should be understood by those skilled in the art that these functional blocks can be implemented in various forms including hardware only, software only, or a combination of the two.

In the embodiment, play data is used as learning data for causing a game operation model that is a machine learning model (or an artificial intelligent model) to learn. The play data may be used as training data in supervised learning. As described above, the play data includes operation information of the input device 6 operated by a player (user) for game play, a user account, a game ID, and a time stamp. The agent generation section 214 uses pieces of play data associated with a plurality of players as training data, to allow the game operation model to learn.

Note that, considering the game operation by the user, during the game play, the user views a game video image (play video image) to recognize the state of the game, operates the input device 6 according to the state of the game, and progresses the game. As a result, in a case in which the play data includes a play video image drawn by the operation information of the input device 6, the game operation model may be trained so as to output the operation information of the input device 6 (or a command of the game), when the game video image that is training data (play video image) is input. In a case in which the game video image is set as an input of the game operation model, the game operation model (machine learning model) may be a convolutional neural network (CNN) corresponding to a multi-layer neural network including an input layer, one or more convolutional layers, and an output layer, and the agent generation section 214 may cause each connection weight (weight) in the CNN to be learnt through a learning method such as deep learning.

The agent generation section 214 may further train the game operation model generated by supervised learning through reinforcement learning, thereby enhancing a play accuracy of the game operation model. The play accuracy can be evaluated with a length of playing time of the game operation model or a state value such as remaining hit points (HP) of a player character.

In a game, such as a role-playing game, having a relatively complicated rule, contents of play may often change for each game scene, and it is not easy to enhance the play accuracy of the AI agent (game operation model) who completes the game from the start of the game. In view of this, in the embodiment, the agent generation section 214 generates an AI agent for each play unit of the game, to enhance the play accuracy of the AI agent dedicated to each play unit. As described above, the game software includes the “activity” that is the first play unit and the “task” that is the second play unit smaller than the first play unit. In addition, the “subtask” that is smaller than the task and that is the third play unit may be included in the game software. The agent generation section 214 generates an AI agent (game operation model) for each play unit described above, to enhance the play accuracy of the AI agent.

The agent generation section 214 refers to a time stamp included in play data and a time stamp included in event data, and specifies play data (operation information and a moving image of a game play) used for each play unit (for example, an activity or a task). For example, when the agent generation section 214 refers to event data associated with a player A and recognizes that the start event of the task a has occurred at 10:00 on January 1st and the end event of the task a has occurred at 10:05 on January 1st, the agent generation section 214 specifies that the play data associated with the player A between 10:00 and 10:05 on January 1st is play data related to the task a. As such, the agent generation section 214 can generate an AI agent for each play unit by specifying play data related to each play unit.

For example, the activity A indicated in FIG. 5 includes the task a, the task b, and the task c. However, in a case in which the agent generation section 214 generates an AI agent dedicated to the activity and an AI agent dedicated to the task, it is expected that the play accuracy of the AI agent dedicated to the task which is small play unit is higher than that of the AI agent dedicated to the activity. Hence, it is preferable that the agent generation section 214 generate the AI agent dedicated to the task which is small play unit. Accordingly, as for the activity A, the agent generation section 214 generates an AI agent dedicated to each of the task A, the task B, and the task C.

The agent generation section 214 evaluates the play accuracy of each of the AI agents with use of an evaluation metric such as a play time, for example. For example, if a play time by the AI agent is longer than an intended play time, the agent generation section 214 determines that the play accuracy of the AI agent is low. In a case in which the play accuracy does not meet a prescribed standard, the agent generation section 214 continues to perform supervised learning and/or reinforcement learning for the AI agent, in order to enhance the play accuracy of the AI agent.

The agent generation section 214 records the AI agent (game operation model) whose play accuracy meets the prescribed standard in the game operation model recording section 236. The AI agent recorded in the game operation model recording section 236 is provided to the user before the start of the game and used for assistance for the game play of the user, or the like.

Note that the agent generation section 214 may generate an AI agent dedicated to the activity A. In a case in which the play accuracy is evaluated by a play time, if a length of playing time for which the AI agent dedicated to the activity A plays the activity A (that is, the task A, the task B, and the task C) is shorter than a total length of playing time of a length of playing time for which the AI agent dedicated to the task A plays the task A, a length of playing time for which the AI agent dedicated to task B plays the task B, and a length of playing time for which the AI agent dedicated to the task C plays the task C, the agent generation section 214 may evaluate that the play accuracy of the AI agent dedicated to the activity A is high. In this case, the agent generation section 214 may record the AI agent dedicated to the activity A in the game operation model recording section 236.

As indicated in FIG. 5, in a case in which the activity includes a plurality of tasks, the agent generation section 214 generates an AI agent dedicated to the activity and an AI agent dedicated to the task and compares play accuracies of both the AI agents with each other, thereby allowing the user to use the AI agent with higher play accuracy. In this manner described above, the server device 5 generates an AI agent dedicated to a play unit from pieces of play data associated with a plurality of players.

Referring back to FIG. 3, the game execution section 112 executes the game on the basis of information regarding an operation of the input device 6 performed by the user. Note that, before the game execution section 112 starts the game, the agent acquisition section 130 acquires the agent generated for the game from the server device 5, in advance. This enables the user to make the agent play the game in place of the user, in the middle of the game. The agent acquisition section 130 records the acquired agent (game operation model) in the auxiliary storage device 2.

As described above, the server device 5 records the agent whose play accuracy meets the prescribed standard in the game operation model recording section 236, while the agent whose play accuracy does not meet the prescribed standard is not recorded in the game operation model recording section 236. Accordingly, a play unit for which the agent is generated and a play unit for which the agent is not generated are present in one game. Hence, the agent acquisition section 130 cannot acquire agents for all play units in the game, and there is a play unit for which the agent cannot be acquired.

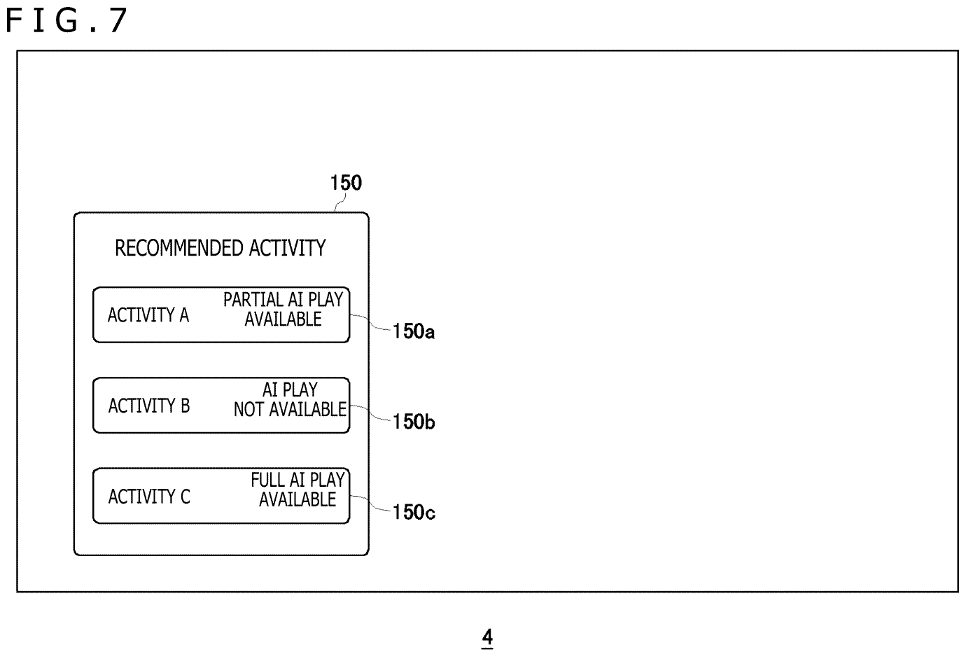

In view of this, the notification section 136 may notify the user of a play unit (an activity or a task) for which the agent can play. FIG. 7 illustrates an example of a notification region 150 displayed on the output device 4. When the user performs a predetermined operation during the game play, the notification section 136 generates information for notifying the user of a recommended activity list and the availability of AI play. When the notification section 136 provides the generated notification information to the output processing section 120, the output processing section 120 displays the notification region 150 including such information in the game image in an overlapping manner. Note that the output processing section 120 may display the notification region 150 on the output device 4 at any time other than during the game play. The notification region 150 indicated in FIG. 7 has a plurality of activities which are recommended to play displayed therein, and an activity A, an activity B, and an activity C are displayed therein.

A display region 150a of the activity A indicates that the game play using the agent is partially available in the activity A. This means that, in a case in which the activity A includes three tasks, for example, the agent is not available for all the three tasks, but the agent is available for at least one task.

A display region 150b of the activity B indicates that the game play using the agent is not available in the activity B. Hence, the user has to play the activity B on his/her own, without relying on the agent.

A display region 150c of the activity C indicates that the game play using the activity is fully available in the activity C. This means that, in a case in which the activity C includes four task, for example, the agent can be used for all the four tasks.

Each of the display regions 150a, 150b, and 150c is constituted as a graphical user interface (GUI), and when the user selects any of the display regions, the output processing section 120 displays a notification region including a task group constituting an activity in the selected display region. Here, it is assumed that the user performs a selection operation of the display region 150a.

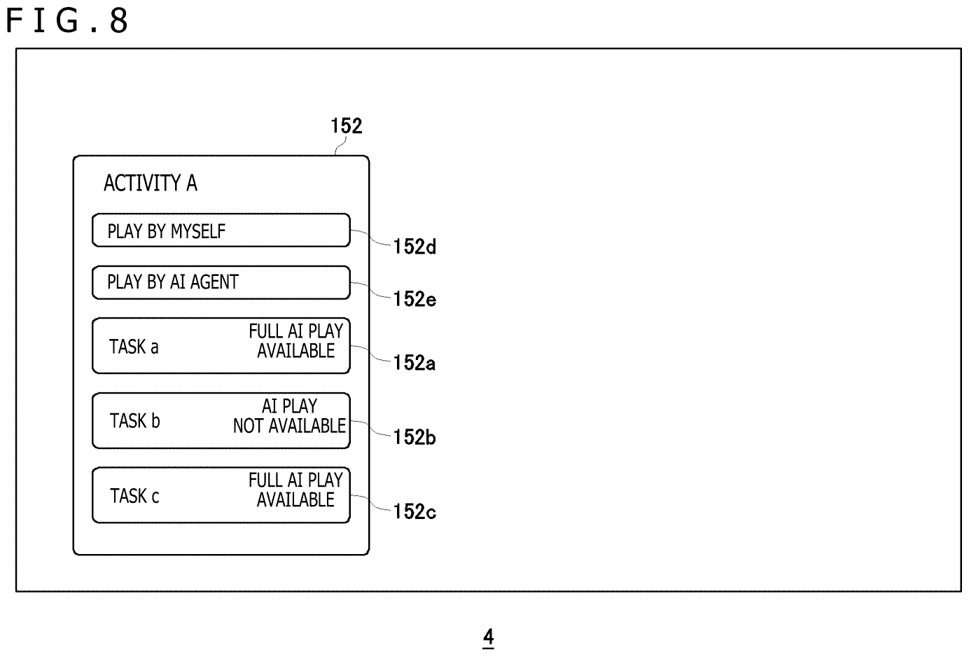

FIG. 8 illustrates an example of a notification region 152 displayed on the output device 4. When the notification section 136 generates information for notifying the user of the task list included in the activity A and the availability of AI play and provides the generated information to the output processing section 120, the output processing section 120 displays the notification region 152 including such information on the game image in an overlapping manner. The notification region 152 illustrated in FIG. 8 has the task a, the task b, and the task c included in the activity A displayed therein.

In a display region 152a of the task a, there is indicated that play using the agent is available in the task a. In a display region 152b of the task b, there is indicated that play using the agent is not available in the task b. In a display region 152c of the task c, there is indicated that play using the agent is available in the task c.

In the notification region 152, when the user performs a selection operation of a user play button 152d that is a button GUI, the reception section 110 provides information regarding the operation performed by the user with the input device 6 to the game execution section 112, and the game execution section 112 executes the game according to the operation information of the user. At this time, the agent is not activated, and the user is assumed to play the game on his/her own.

In a case in which the user wants the agent to play a task, the user may select the task which the user wants the agent to play. For example, in a case in which the user wants the agent to play the task a and the task c, the user presses the display region 152a and the display region 152c once and sets these display regions to a selected state, thereafter performing a selection operation of an AI play button 152e button that is a button GUI. When the AI play button 152e is selected, the game play controller 132 activates the agent, and the game execution section 112 executes the game according to the operation information of the agent. Note that, in the play unit (task b) without the agent, the agent cannot be activated, and therefore, the game execution section 112 executes the game according to operation information of the user.

In a case in which the user wants the agent play only for the task a, the user presses the display region 152a once and sets the display region 152a to the selected state, and thereafter, the user selects the AI play button 152e. In addition, in a case in which the user wants the agent play only for the task c, the user presses the display region 152c once and sets the display region 152c to the selected state, and thereafter, the user selects the AI play button 152e. In this manner, an operation of selecting the play unit is received by the reception section 110, and the game play controller 132 activates the agent corresponding to the play unit selected by the user, to cause the agent to play the game.

In the following description, in a state in which the task a and the task c are being selected, a behavior when the user selects the AI play button 152e will be described. At this time, the game play controller 132 activates the agent (game operation model) of the task a. The agent generates, as a player, operation information (or a game command) for the game, and the game execution section 112 executes a game program of the task a, according to operation information of the agent. In this manner, when the user makes a request to the agent for play, the game play controller 132 activates the agent, and causes the agent to play the game in place of the user.

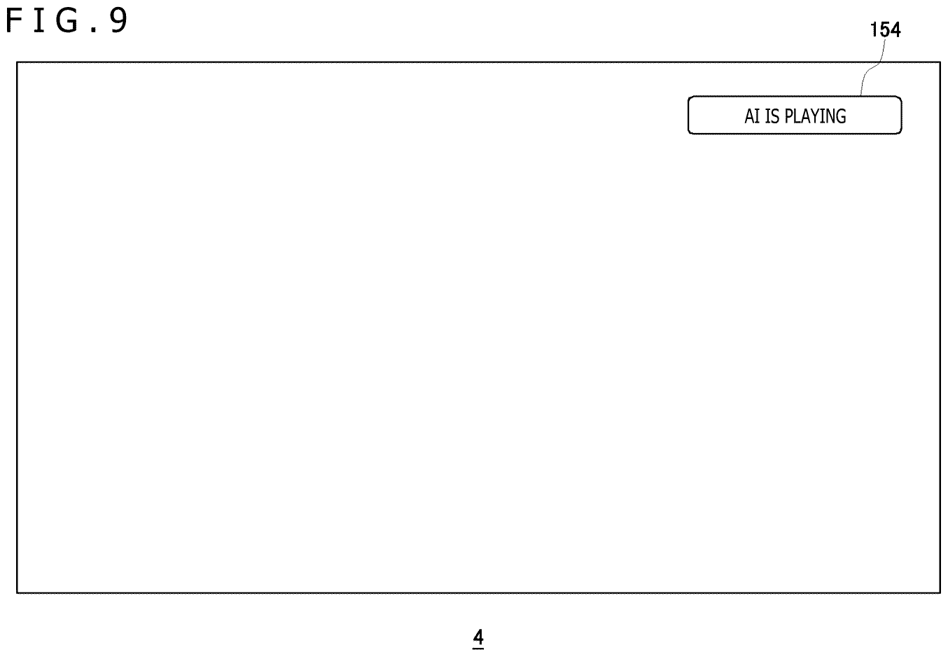

FIG. 9 illustrates an example of a notification region 154 displayed while the task a is being played by the agent. While the game play is being performed by the agent, the notification section 136 generates information for notifying the user of the agent playing the game and provides the generated information to the output processing section 120, and the output processing section 120 displays the notification region 154 including such notification information on the game image in an overlapping manner. Hence, the user can recognize that the agent is playing the game.

With reference to FIG. 8, while the agent dedicated to the task a is present in the activity A, the agent dedicated to the task b is not present. Accordingly, when the agent finishes playing the task a, the task b subsequent to the task a is required to be played by the user on his/her own.

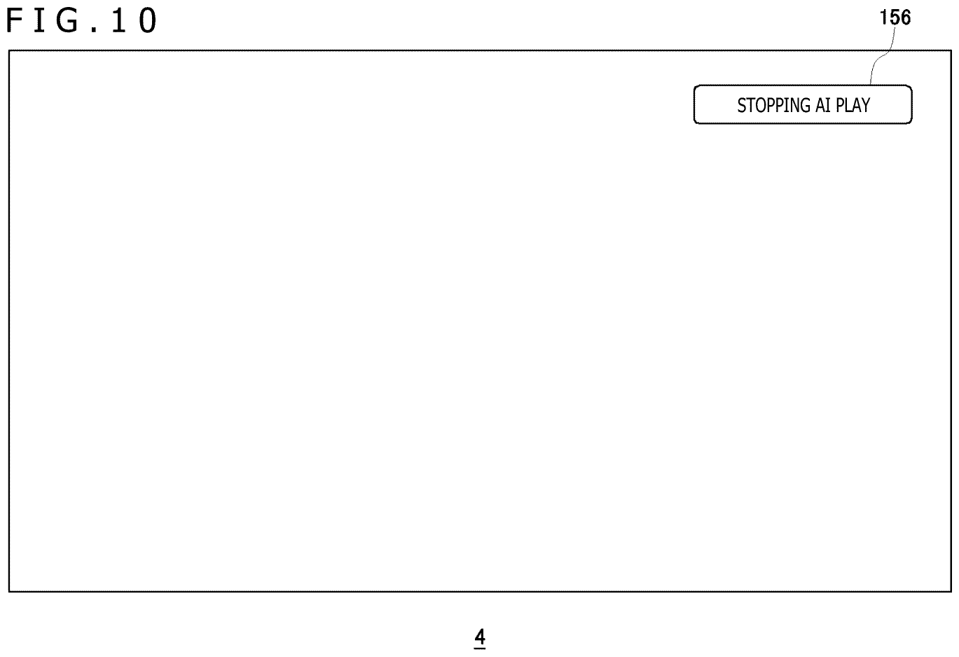

FIG. 10 illustrates an example of a notification region 156 displayed when the task a played by the agent has been finished. The notification section 136 generates information for notifying the user that the play by the agent will be finished, and provides the generated information to the output processing section 120, and the output processing section 120 displays the notification region 156 including such notification information on the game image in an overlapping manner. Hence, the user recognizes that the user has to play the game on his/her own, and starts to operate the input device 6.

When the user finishes playing the task b, the game play controller 132 activates the agent (game operation model) of the task c. The agent generates operation information for the game, and the game execution section 112 executes the game program of the task c according to the operation information of the agent. At this time, the output processing section 120 displays the notification region 154 illustrated in FIG. 9 on the game image in an overlapping manner.

In the examples described above, the user selects an activity from the notification region 150 and makes a request to the agent for the game play. Alternatively, the output processing section 120 may present the notification information indicating that the agent is available, to the user.

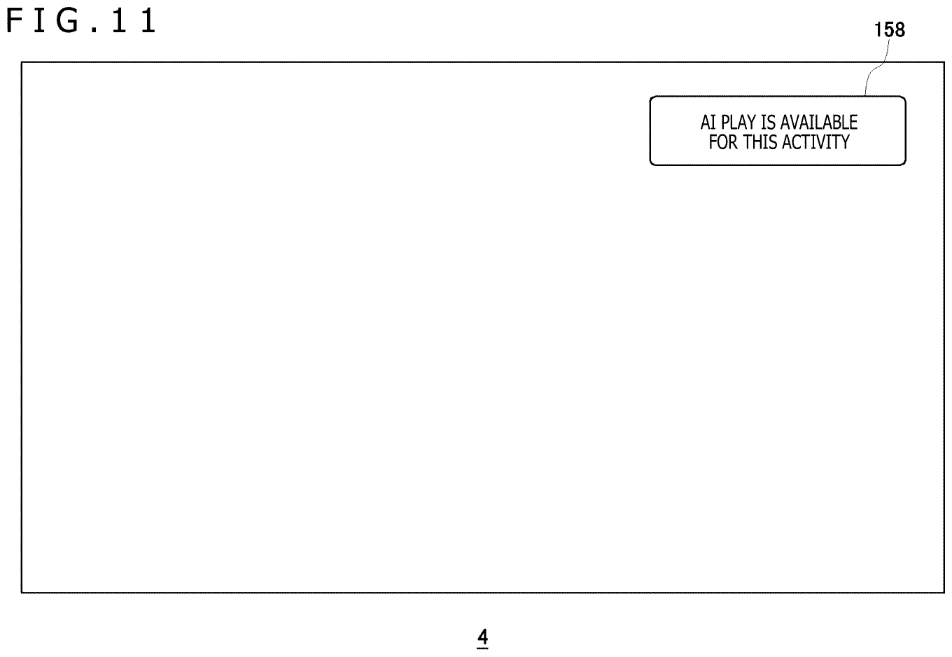

FIG. 11 illustrates an example of a notification region 158 displayed when the agent play is available. When a scene of a play unit in which the agent has been generated is displayed, the notification section 136 generates notification information indicating that the agent can play, and provides the generated information to the output processing section 120, and the output processing section 120 displays the notification region 158 including such notification information on the game image in an overlapping manner. Accordingly, the user can recognize that the agent is available. For example, when the user selects the notification region 158, the game play controller 132 may activate the agent and start play performed by the agent.

Note that, while the agent is playing the game, the user performs a predetermined operation, so that control of the game can be returned to the user. For example, the user has the notification region 152 displayed and selects the user play button 152d, and accordingly, control of the game may be returned back to the user. In addition, it may be set up such that, when the user operates the input device 6 while the agent is playing the game, control of the game is returned to the user.

Moreover, in a state in which the user has control of the game, when the user leaves the input device 6 without performing any operation for a predetermined period of time, it may be set up such that the control of the game moves to the agent. Further, in a case in which the user fails to succeed a task, the notification section 136 may generate notification information indicating that the agent is available, and the output processing section 120 may display the generated notification information on the game image in an overlapping manner. When the game progress by the user has come to a halt, proposing the use of the agent can assist play of the user.

As described above, the present disclosure has been described according to the embodiment. The foregoing embodiment is illustrative, and it is to be understood by those skilled in the art that combinations of constituent elements and processing processes of the embodiment are susceptible of various modifications and that such modifications also fall within the scope of the present disclosure. While the agent is used as a player in place of the user in the embodiment, the agent can instead be used for generation of a help video (tutorial video), for example. Moreover, the agent can also be used for a non player character (NPC).

In the embodiment, the game execution section 112 is provided in the information processing device 10. In a modification example, the game execution section 112 may be provided in the server device 5, so that the game system 1 may provide a cloud gaming service. In this case, the server device 5 may also include the game play controller 132, and the server device 5 may function like the information processing device 10.

At the time of learning of the agent in the server device 5, it is only sufficient if the required play accuracy for the agent may be moderately high, and there is no need to set the required play accuracy of the agent to be extremely high. For example, the required play accuracy for the agent may be as high as that of a player having an average skill. That is, it is sufficient if the required play accuracy of the agent may be one that a human can reasonably achieve, and it is not necessary to require a fast play that is impossible for humans to achieve.

In the embodiment, there is provided an example in which learning for the task b does not go well and the play accuracy of the agent in the task b cannot be improved. This can be considered that the task b is not an appropriate play unit for learning.

In view of this, the game manufacturer preferably uses an analysis apparatus that can propose an idea of dividing a play unit into segments of a reasonable length that the agent can easily learn, when developing game software. For example, in game software being developed, when the game developer plays a play unit (for example, a task) as a test, the analysis apparatus may determine whether the game is easy to learn, from operation information and a play video image during test play.

More specifically, the analysis apparatus analyzes operation information and a play video image for one play unit, and in a case in which contexts (contents of play) have changed, the analysis apparatus proposes that the play unit be divided. When the analysis apparatus analyzes operation information in a chronological order, in a case in which there is a long period of inactivity or an operation for a menu display is often performed, the analysis apparatus determines that the relevant play unit is long and unsuitable for learning, and may propose that the relevant play unit be divided. In addition, when the play video image is analyzed in a chronological order, in a case in which there is a large change between scenes, the analysis apparatus determines that the relevant play unit includes a plurality of play contents, and may propose that the relevant play unit be divided. In this manner, when the analysis apparatus detects a change in play contents from operation information and a play video image in one play unit temporarily set, the analysis apparatus may propose to the game manufacturer that the one play unit be divided.

### Industrial Applicability

The present disclosure can be used for a technique in which the agent plays the game in place of the user.

### REFERENCE SIGNS LIST

1: Game System
5: Server device
6: Input device
10: Information processing device
100: Processing unit
102: Communication unit
110: Reception section
112: Game execution section
114: Game image and sound generation section
116: Game image generation section
118: Game sound generation section
120: Output processing section
122: Play data acquisition section
130: Agent acquisition section
132: Game Play Controller
134: Event information acquisition section
136: Notification section
140: Transmission processing section
200: Processing unit
202: Communication unit
210: Play data acquisition section
212: Event data acquisition section
214: Agent generation section
216: Agent provision section
230: Recording device
232: Play data recording section
234: Event data recording section
236: Game operation model recording section

1. An information processing device comprising:
one or more processors including hardware,
wherein the one or more processors
accept operation information input by a user,
execute a game according to the operation information,
notify the user of a play unit in which play by an agent is available, and
cause the agent to play the play unit in place of the user.

2. The information processing device according to claim 1, wherein the one or more processors accept an operation of selecting a play unit in which the play by the agent is available, and cause the agent to play the selected play unit.

3. The information processing device according to claim 1, wherein the one or more processors display information indicating that the agent is playing the play unit, while the agent is playing the play unit.

4. The information processing device according to claim 2, wherein the one or more processors display information indicating that the play by the agent is to be stopped, when the play by the agent is not available.

5. The information processing device according to claim 1, wherein the one or more processors display information indicating that the play by the agent is available, in a case in which the play by the agent is available while the user is playing the play unit.

6. The information processing device according to claim 1, wherein the agent is generated for each play unit, and the one or more processors cause a different agent to play each play unit.

7. A game play method for playing a game by an information processing device, comprising:
accepting operation information input by a user;
executing a game according to the operation information;
notifying the user of a play unit in which play by an agent is available; and
causing the agent to play the play unit in place of the user.

8. One or more non-transitory computer-readable media storing computer-readable instructions that, when executed by one or more processors, cause a system to perform operations comprising:
accepting operation information input by a user;
executing a game according to the operation information;
notifying the user of a play unit in which play by an agent is available; and
causing the agent to play the play unit in place of the user.
